(19) United States
(12) Patent Application Publication
(10) Pub. No.: US 2024/0005343 A1
(43) Pub. Date: Jan. 4, 2024

(54) DATA INTERROGATOR FOR EDI MAPPING AND MIGRATION

(71) Applicant: OPEN TEXT HOLDINGS, INC., Menlo Park, CA (US)

(72) Inventors: Brian Pinci, Gaithersburg, MD (US); Carey Wachtel, Canton, OH (US); Balasamy Pandian, Hoffman Estates, IL (US); Ray Weiguang Chu, Falls Church, VA (US)

(21) Appl. No.: 18/346,199

(22) Filed: Jun. 30, 2023

Related U.S. Application Data
(60) Provisional application No. 63/357,532, filed on Jun. 30, 2022.

(51) Int. Cl. G06Q 30/0201; G06F 16/23

(52) U.S. Cl. CPC G06Q 30/0201; G06F 16/2365

(57) ABSTRACT

A data analyzer may receive a superset and a data interrogation report from a client device. The superset corresponds to a document type and contains columns for tracking field names, usage count, and trading partners of an enterprise. The data interrogation report contains field names, usage data, and trading partner data. The data analyzer validates the superset and the data interrogation report, updates the superset with information from the interrogation report, and generates a data analysis report for user download. The data interrogation report is generated by a data interrogator from client-provided data. The data interrogator determines a document format and creates an appropriate internal definition if necessary. The data interrogator is operable to process the client-provided data and summarize field-level metadata by trading partner. The data interrogator and the data analyzer can be part of a data discovery and analysis service provided by an information exchange platform.

### CROSS-REFERENCE TO RELATED APPLICATION(S)

This application claims a benefit of priority under 35 U.S.C. § 119(e) from Provisional Application No. 63/357,532, filed Jun. 30, 2022, entitled “DATA INTERROGATOR FOR EDI MAPPING AND MIGRATION,” the entire contents of which, including the appendixes, are incorporated by reference herein for all purposes.

### TECHNICAL FIELD

This disclosure relates generally electronic information exchange in a network computing environment. More particularly, this disclosure relates to a data interrogator useful for electronic data interchange mapping and migration over a network.

### BACKGROUND OF THE RELATED ART

Electronic Data Interchange (EDI) generally refers to the computer-to-computer exchange of business documents between trading partners. Today, technical standards for EDI exist to facilitate trading partners electronically exchanging information in a standard electronic format without having to make special arrangements. Examples of trading partners may include enterprises, corporations, companies, agencies, etc. An example of a network environment may include a distributed computer network, a cloud computing environment, or the Internet.

In this context, an information exchange platform may operate to facilitate the real-time flow or exchange of information between disparate entities regardless of standards preferences, spoken languages, or geographic locations. An information exchange platform may be embodied on server machines that support electronic communication methods used by various computers that are independently owned and operated by different entities.

Such an information exchange platform may support data formats including standardized EDI, Extensible Markup Language (XML), RosettaNet, EDI-INT, flat file/proprietary format, etc. Supported network connectivity may include dial-up, frame relay, AS2, leased line, Internet, etc. Supported delivery methods may include store-and-forward mailbox, event-driven delivery, etc. Supported transport methods may include Hypertext Transfer Protocol (HTTP), File Transfer Protocol (FTP), and Simple Mail Transfer Protocol (SMTP), etc. Supported network security protocols may include Secure Socket Layer (SSL), Secure/Multipurpose Internet Mail Extensions (S/MIME), Internet Protocol Security (IPSEC), Virtual Private Network (VPN), Pretty Good Privacy (PGP) encryption protocol, etc.

The information exchange platform may provide managed services that can help an enterprise manage day-to-day business-to-business (B2B) integration environments to optimize, for instance, enterprise resource planning (ERP), supply chain operations, customer service, etc. When an enterprise faces a big project such as an ERP system migration, lacking insights on key supply chain data can cause major delays, incur unnecessary costs, and even disrupt business processes. However, gaining these insights can be challenging and expensive. The invention disclosed herein can address these challenges and more.

### SUMMARY OF THE DISCLOSURE

Integrating B2B data in ERP systems relies on EDI standards, such as ANSI X12 and EDIFACT, that enable organizations and enterprises alike to exchange documents and other information with their trading partners in a structured format. However, there are multiple EDI standards, each of which has several versions, and only a fraction of all the data attributes that are defined in a given EDI standard are used in a typical integration flow. Most organizations have developed proprietary B2B programs over the years, on a project-by-project basis. As a result, few have an overarching and well-documented view into their integrations that covers all of the details, which makes gaining insights on key supply chain data extremely challenging and expensive.

Embodiments disclosed herein are directed to a Data Discovery and Analysis (DDA) service with a data analysis and a data interrogator useful for gaining insights on EDI mapping and migration over a network and reporting same to an enterprise customer of the DDA service in a wholistic, centralized manner, providing a unified view into the enterprise's supply chain data.

Embodiments of the DDA service disclosed herein can leverage automated tools such as a data interrogator to interrogate large quantities of business transactions, such as purchase orders, order confirmations, shipment notices, and so on. The automated tooling is operable to summarize and report the detailed content of these transactions and identify the specific standards, versions and individual data attributes used by each trading partner exchanging B2B messages with an enterprise customer of the DDA service. By interrogating large sets of data, even one-off and rare data requirements can be identified and reported alongside the more common requirements. The ability to review and compare the requirements of different trading partners simultaneously based on a harmonized view of the data also enables identifying identical trading partner behaviors, which can be managed using shared data maps to help reduce the costs of integration.

The client provides historical B2B and ERP data files for analysis. The files can include standard EDI files (e.g. EDIFACT, X12, VDA, TRADACOMS, etc.), ERP data files (e.g. SAP IDoc, XML, etc.), or both. EDI files can be analyzed as such, whereas the ERP data files will need to be accompanied by supporting information about the file structure, such as SAP parser files for SAP IDoc or the XML schemas for XML files.

Upon receiving the files, a business analyst interrogates and analyzes the data using the automated data interrogator and data analyzer disclosed herein to produce a client-specific ERP/B2B reference data model and applicable reports to summarize the findings. The data model and the reports are then shared with the client in a workshop to review the key findings and recommended actions based on them.

In some embodiments, a method may comprise receiving, from a client device, a superset and a data interrogation report, the superset corresponding to a document type and containing a column tracking a field name, a column tracking a usage count for the field name, and columns tracking trading partners of an enterprise, the data interrogation report containing field names, usage data, and trading partner data. The data analyzer validates the superset and the data interrogation report, updates the superset with information from the interrogation report, generates a data analysis report based on the updating, and sends the data analysis report to the client device for user download.

In some embodiments, the data interrogation report is generated by a data interrogator. In some embodiments, the data interrogator and the data analyzer can be part of a data discovery and analysis service provided by an information exchange platform.

In some embodiments, generation of the data interrogation report can comprise receiving a package from the client device, the package containing a file, determining whether the file has an Electronic Data Interchange (EDI) format, and responsive to the file not having the EDI format, determining a format of the file, and creating, on the fly, an internal definition corresponding to the format of the file. In some embodiments, the format of the internal definition can comprise an XML-type internal definition, an iDOC-type internal definition, a JSON-type internal definition, or a flat file-type internal definition. In some embodiments, generation of the data interrogation report can further comprise summarizing field-level metadata by trading partner.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a diagrammatical representation of an information exchange platform operating in a distributed network environment according to some embodiments

FIG. 2 depicts a flow diagram that illustrates an example of operations performed by a data interrogator according to some embodiments.

FIG. 3, which depicts a diagrammatical representation of an example of data interrogator according to some embodiments.

FIG. 4A shows an example of an XML-type internal definition in an XML format that is consumable by a data interrogator according to some embodiments.

FIG. 4B depicts a diagrammatical representation of a visual representation of an internal definition according to some embodiments.

FIG. 5 depicts a diagrammatic representation of an example of a user interface for a data interrogator according to some embodiments.

FIG. 6 depicts a diagrammatic representation of an example of a user interface that shows an output package according to some embodiments.

FIG. 7 depicts a diagrammatic representation of an example of a user interface for a data analyzer according to some embodiments.

FIG. 8 shows an example of a correlation spreadsheet according to some embodiments.

FIG. 9 shows an example of a data interrogation report according to some embodiments.

FIG. 10 depicts a diagrammatic representation of an example of a user interface of a data analyzer having an EDI structure feature according to some embodiments.

FIG. 11 shows an example of a flow run by a data analyzer according to some embodiments.

FIG. 12 depicts a diagrammatic representation of an example of a user interface of a data analyzer showing a completed job that a user can download according to some embodiments.

FIG. 13 shows a portion of an example of a data analysis report dynamically generated by a data analyzer disclosed herein according to some embodiments.

FIG. 14 depicts a diagrammatical representation of an example of the logical architecture of a data analyzer according to some embodiments.

FIG. 15 depicts a logical diagram that illustrates the functionalities of a data interrogator according to some embodiments.

FIG. 17 depicts a diagrammatic representation of a data processing system for implementing an embodiment disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

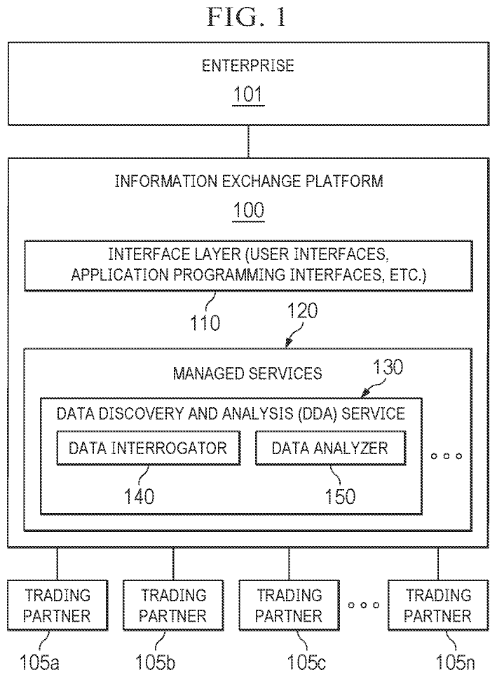

FIG. 1 depicts a diagrammatical representation of an information exchange platform 100 operating in a distributed network environment according to some embodiments. The information exchange platform may provide managed services (e.g., managed services 120) to an enterprise customer (e.g., enterprise 101) through an interface layer (e.g., interface layer 110) that includes various interfaces (e.g., user interfaces (UIs), application programming interfaces (APIs), etc.) necessary for the information exchange platform to communicate with the enterprise, including enterprise users and systems.

In embodiments disclosed herein, the managed services include a Data Discovery and Analysis (DDA) service (e.g., DDA service 130). To gain insights on key supply chain data, the DDA service leverages automated, computerized tools (e.g., data interrogator 140 and data analyzer 150) to interrogate client-provided data files (e.g., B2B data files, ERP data files, etc.), analyze large quantities of B2B and ERP documents contained therein (e.g., purchase orders, order confirmations, shipment notices, and so on), including interpreting and summarizing field-level metadata, and report the findings to the client via a unified view presented through a UI. Other types of managed services (not shown) may include translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc.

In some embodiments, the DDA service can provide an enterprise with a harmonized view (e.g., via a UI) that summarizes all the B2B message types, data attributes, and processing rules involved in exchanging documents with the enterprise's trading partners (e.g., trading partners 105a, 105b, 105c, . . . , 105n). These insights can be used for various purposes, such as supporting blueprinting of new systems, managing migration-related risks, optimizing integration map usage, and remedying issues with trading partner behavior.

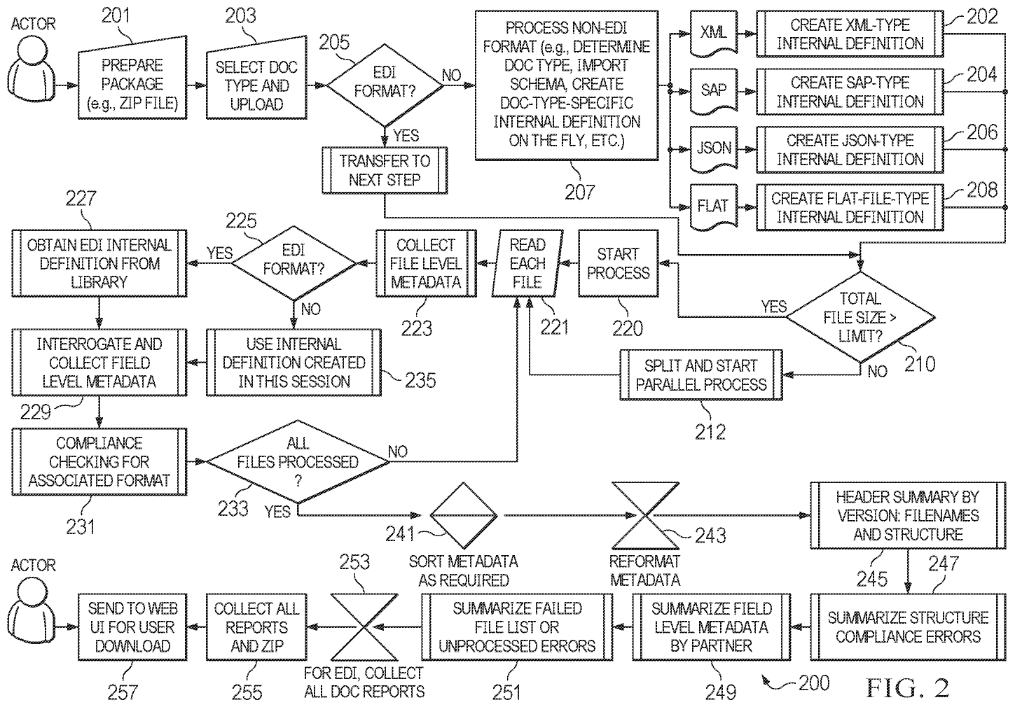

FIG. 2 depicts a flow diagram that illustrates an example of operations performed by a data interrogator according to some embodiments. In this example, flow 200 begins with an actor preparing a package (e.g., a zip file packaged with data files (e.g., B2B and/or ERP documents such as purchase orders, order confirmations, shipment notices, etc.) (201). As a non-limiting example, the actor can be an authorized user of an enterprise customer of the DDA service. Through an UI of the DDA service (which can be implemented as a web based application), the actor selects a document type and uploads the package (203).

Once the packaged is received, the data interrogator is operable to examine the package and determine whether the user-selected document type follows the EDI format (205). If so, flow 200 transitions to checking the file size (210). Otherwise, additional processing is necessary (207). The data interrogator leverages a mapping mechanism (e.g., a mapper, a mapping engine, etc.) to discover and fix anomalies in source data (e.g., input files) using internal definitions. As a non-limiting example, the mapping mechanism can implement the Mapping Engine Kernel (MEK) engine available from OPEN TEXT, headquartered in Waterloo, Canada. Other mappers can also be used for various implementations.

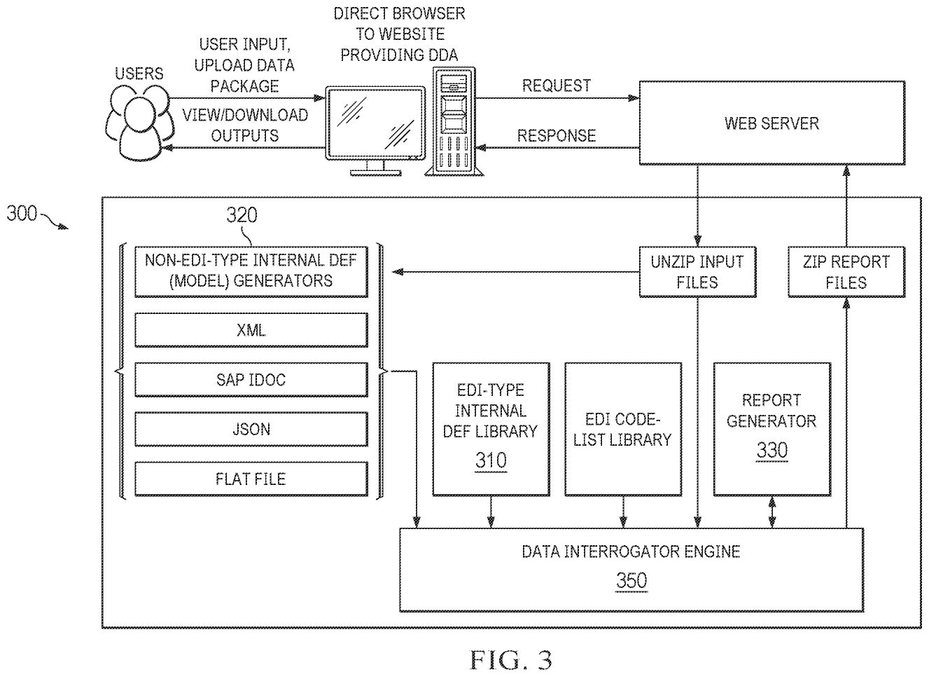

The internal definitions are needed by a parser (which can be implemented as part of the mapper) to parse the source data. For documents in the EDI format, an EDI-type internal definition (generated based on a published EDI standard commonly used in the industry) can be obtained from an internal library. FIG. 3, which depicts a diagrammatical representation of an example of data interrogator 300 according to some embodiments, shows an example of an EDI-type internal definition library 310 that is internal to data interrogator 300.

For documents in non-EDI formats, appropriate internal definitions will need to be generated on the fly. In the example of FIG. 3, data interrogator 300 further includes non-EDI-type internal definition generators 320. As a non-limiting example, to create an XML-type internal definition, a generator is operable to obtain an XML schema (from a user or a data source). The XML schema defines a structure that can be used to create an XML-type internal definition on the fly.

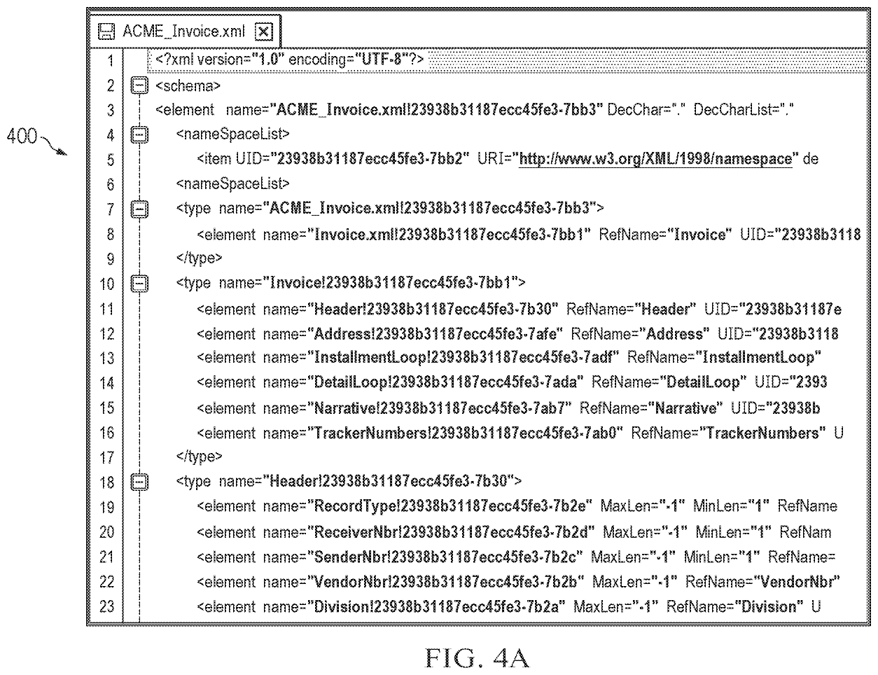

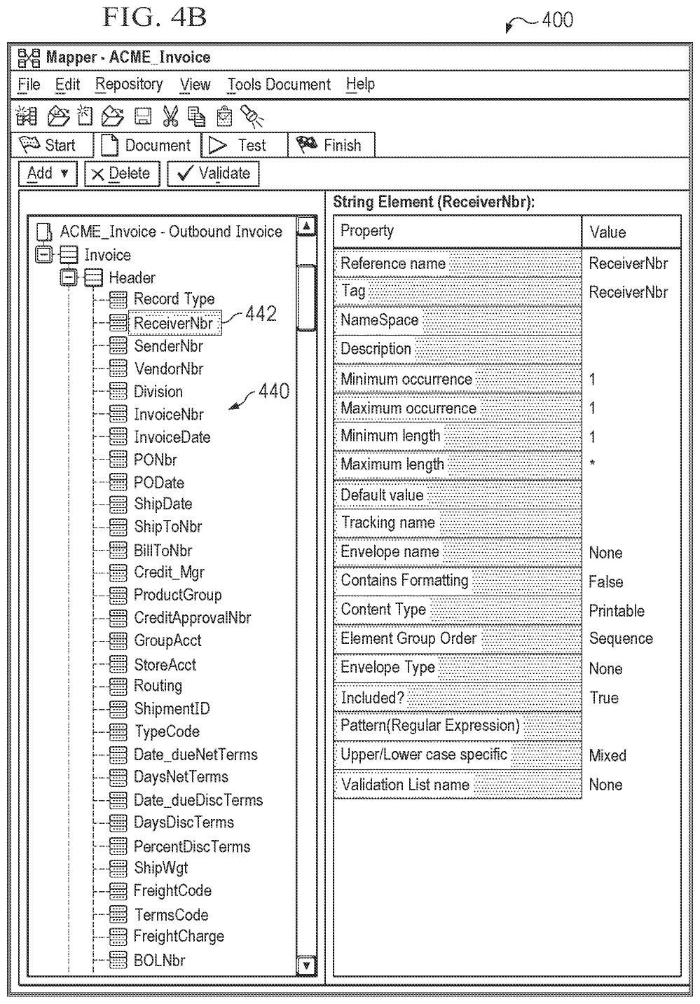

FIG. 4A shows an example of an XML-type internal definition 400 in an XML format that is consumable by the data interrogator (e.g., data interrogator 300) according to some embodiments. FIG. 4B depicts a diagrammatical representation of a visual representation of internal definition 400 according to some embodiments. In this visual representation, internal definition 400 has tree structure 440 with nodes. Each node (e.g., node 442) has attributes (properties) and each attribute has an value.

In some embodiments, tree structure 440 represents an enhanced document-object-model (DOM) object. Thus, XML-type internal definition 400 can also be characterized as an enhanced DOM object or XML model. For this reason, non-EDI-type internal definition generators 320 shown in FIG. 3 may also be referred to herein as model generators. These model generators are operable to create other non-EDI-type models (internal definitions) in a similar manner as described above. XML, SAP IDOC, JSON, and flat files are known to those skilled in the art and thus are not further described herein.

Referring back to FIG. 2, once non-EDI-type internal definitions 202, 204, 206, 208 are created on the fly, flow 200 transitions to checking whether the file size exceeds a predetermined limit (210). If so, the data interrogator splits the input data and starts a parallel data interrogation process (212). Depending upon implementation, the data interrogator may proceed to start a data interrogation process (220) with or without first checking the file size. In some embodiments, the data interrogation process is performed by a data interrogator engine of the data interrogator (e.g., data interrogator engine 350 shown in FIG. 3).

In some embodiments, the data interrogation process may entail reading each input file (221) and collecting file level metadata from the input file (via a parser) (223). Based on the file level metadata, the data interrogation process is operable to determine whether the input file is in the EDI format (225). If so, an EDI-type internal definition is obtained from the internal library (227). Otherwise, an appropriate non-EDI-type internal definition (e.g., non-EDI-type internal definitions 202, 204, 206, or 208) created in the session is used (235). The data interrogator, using the parser which now has the necessary internal definition, is operable to interrogate and collect field-level metadata from the input file (229). In some embodiments, the data interrogator may perform additional processing such as compliance checking for the associated format of the input file being processed (231).

The data interrogator iteratively processes the input files until all the files from the package are processed (233). The data interrogator may then sort the collected metadata as required (by rules) (241) and reformat the metadata as necessary (243) so as to generate a header summary by EDI version (245). The data interrogator may summarize structure compliance errors (247), summarize field level metadata by trading partner (e.g., trading partners 105a, 105b, 105c, . . . , 105n of enterprise 101), and summarize failed file list or unprocessed errors (251).

In some embodiments, the data interrogator may include a report generator (e.g., report generator 330 shown in FIG. 3) that is operable to generate reports utilizing summarized results provided by the data interrogator engine. These reports are collected (253). packaged (255), and communicated to a web based UI for user download (257).

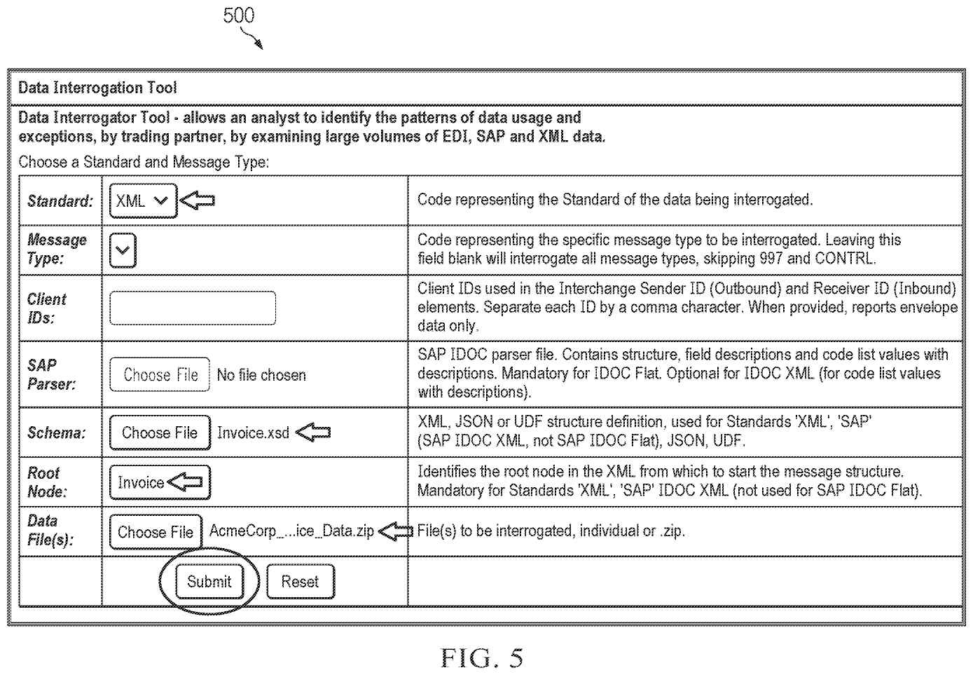

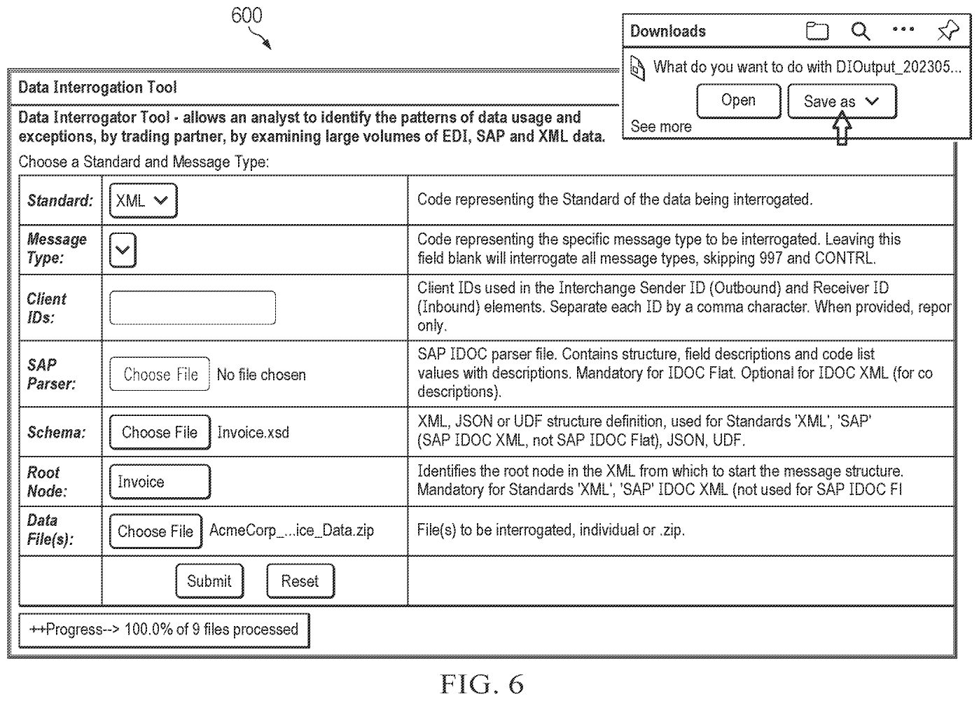

FIG. 5 depicts a diagrammatic representation of an example of UI 500 for a data interrogator according to some embodiments. Through UI 500, a user can select an appropriate format and a corresponding schema and choose file(s) to be interrogated. The data interrogator processes the input and generates data interrogator (DI) reports. FIG. 6 depicts a diagrammatic representation of an example of UI 600 that shows an output package (which contains the generated DI reports) is ready for download. At this time, the user can download the output package generated by the data interrogator to a desired location and move on to a data analyzer application.

The data interrogator can read bulk source data (e.g., hundreds to tens of thousands of input files) one input file at a time to understand the data structure of each input file, analyze the content using internal definitions, obtain field level metadata, summarize the findings, and generate reports. In some embodiments, during the data interrogation process, the data interrogator engine is operable to discover and fix anomalies in the source data using the internal definitions (enhanced models). The enhanced models disclosed herein can perform better than artificial intelligence (AI) models in representing specifications of EDI standards.

The AI models are more rigid with built-in, fixed features (e.g., compliance checks). For example, a parser implementing an AI model will parse an input record with no observer pattern and no inversion of control. With the enhanced models, the parser is separated from the data interrogator engine, allowing an any-to-any mapping paradigm. The parser performs the parsing task and the data interrogator engine performs the data interrogation task. Through a predefined observer pattern, the data interrogator engine can decide what action to take (e.g., via a call back) when a certain event of interest occurs.

Even so, the enhanced models do not change the data interrogator flow or the final output (e.g., a data interrogation report). The enhanced models follow a universal DOM, allowing the data interrogator to support all types of document structures (e.g., hierarchical, looping, repeating, records, fields, etc.). Further, when an updated is needed, for instance, due to a compliance reason, instead of changing an internal definition, the data interrogator engine can be modified to take an appropriate action for the compliance check. This allows for the data analyzer to continue taking the output from the data interrogator as input without having to modify the data analyzer or the output that it generates.

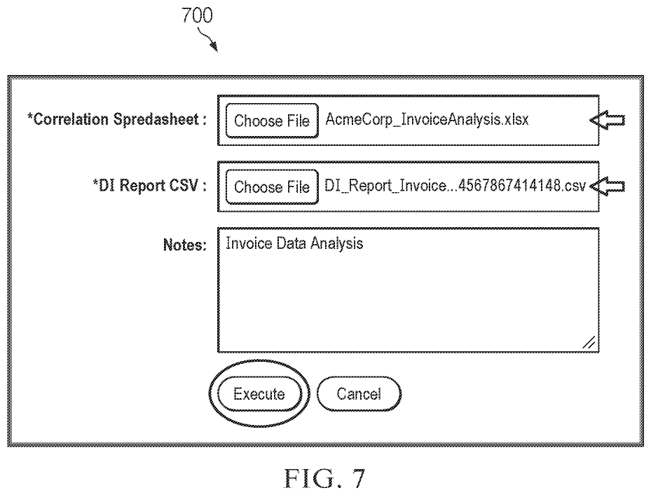

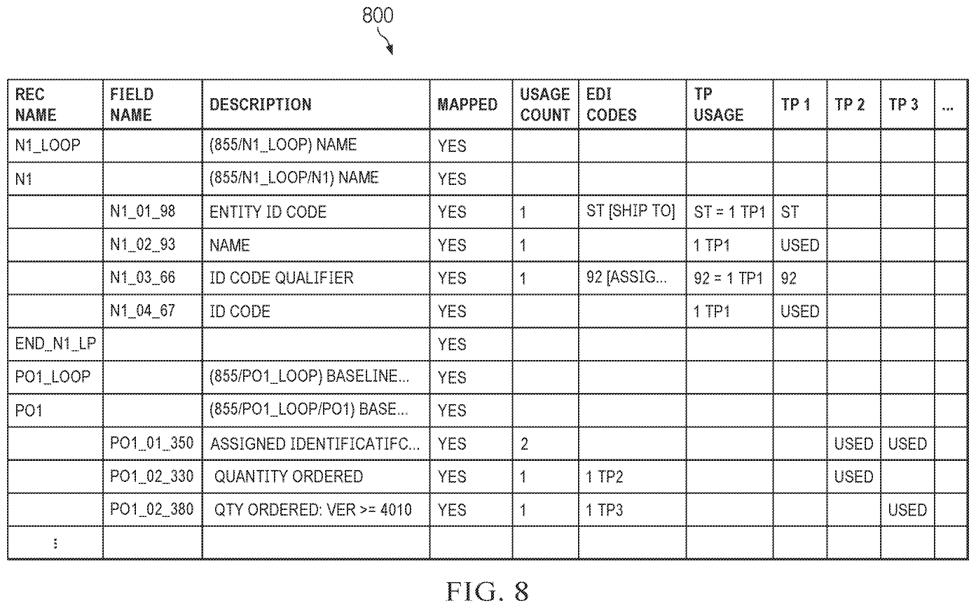

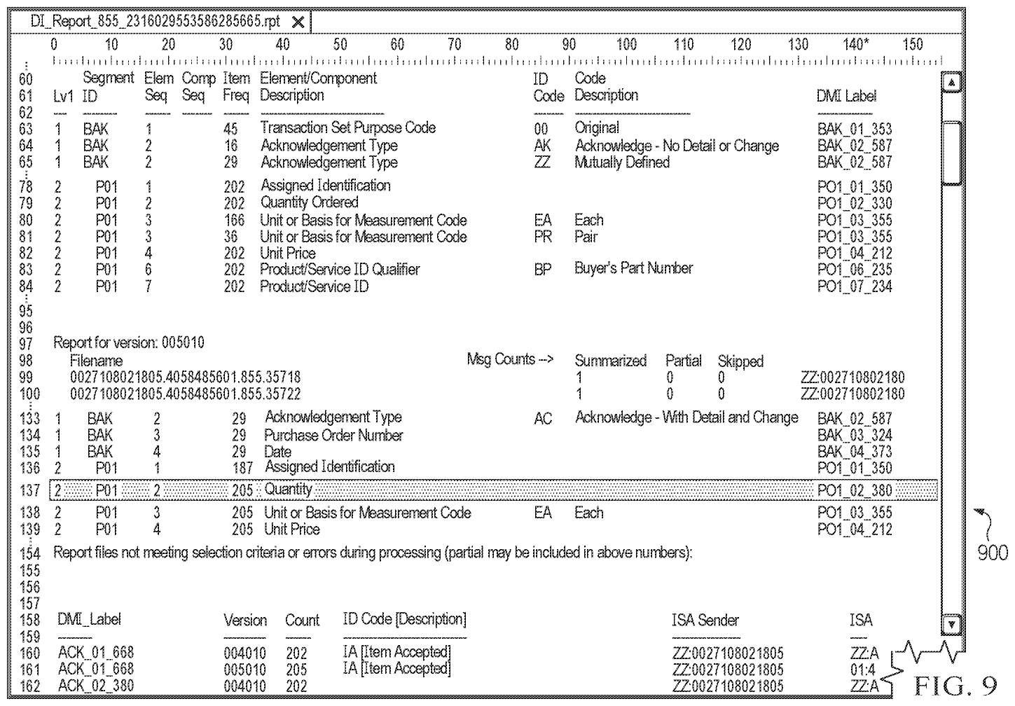

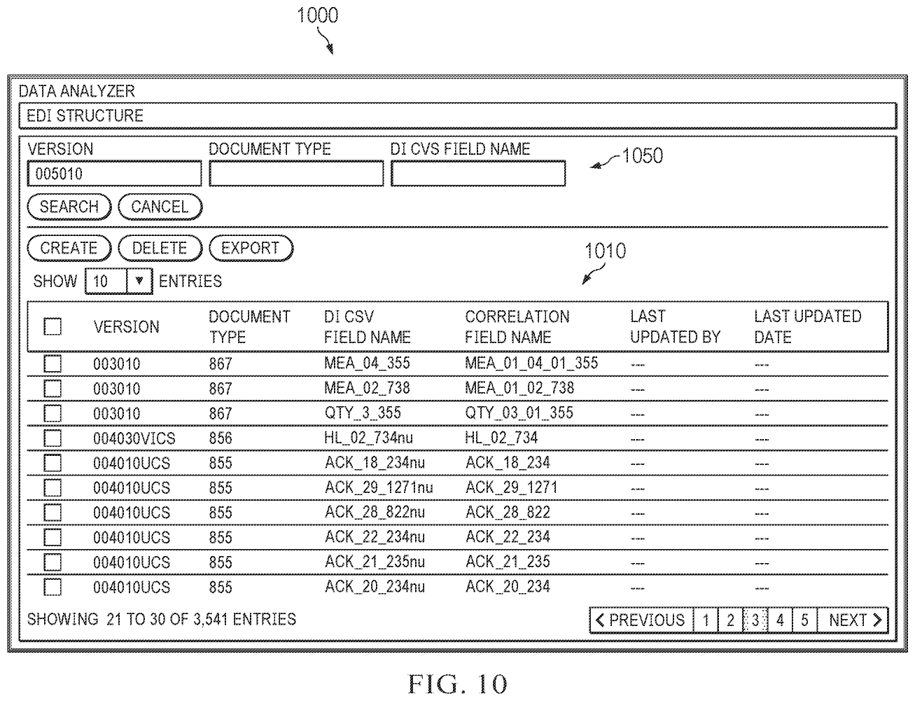

FIG. 7 depicts a diagrammatic representation of an example of UI 700 for a data analyzer according to some embodiments. Through UI 700, a user can select a correlation spreadsheet and a DI report generated by the data interrogator. FIG. 8 shows an example of a correlation spreadsheet 800 according to some embodiments. FIG. 9 shows an example of a DI report 900 according to some embodiments.

As discussed above, the enterprise customer of the DDA service and the enterprise customer's trading partners may follow different EDI standards. Even if they follow the same EDI standard, there can be multiple different versions of the same EDI standard. Different EDI standards and versions thereof define different field names and the locations of such field names may also be different. As illustrated in FIG. 8, the correlation spreadsheet can be implemented as a database having a unified data structure with a column for EDI field names, a column for corresponding descriptions of the EDI fields, a column indicating whether a respective EDI field is mapped to another field, a column for usage count, a column for applicable EDI Codes, a column for usage by respective trading partner(s), a column for each trading partner of the enterprise, and so on. The correlation spreadsheet, which is referred to herein as the “superset” and which is version-agnostic, can be created based on specifications of EDI standards and can cross reference disparate EDI field names used by different EDI standards/versions in the unified data structure. The data analyzer takes the superset and the DI report generated by the data interrogator and updates the superset accordingly.

While a superset may involve hundreds of EDI versions and/or standards, a non-limiting example below illustrates the utility and functionality of the superset. The superset leverages a database, referred to herein as an EDI structure, to cross reference field names across EDI versions. The EDI structure includes tables, each for a particular EDI version. Each table tracks, per entry, which field name in the DI report (“DI CSV field name”) points to what correlation field name in the superset. FIG. 10 depicts a diagrammatic representation of an example of UI 1000 of a data analyzer having an EDI structure feature, which can be accessed via a menu of the data analyzer, with the EDI structure feature as one of the menu items. As illustrated in FIG. 10, the EDI structure feature includes a filter function (e.g., filter 1050) which can be used to filter entries in an EDI structure (e.g., database 1010) by version, document type, field name, etc.

Suppose the superset tracks one document type (e.g., “867”), three trading partners, and two EDI versions and further suppose that the two EDI versions specify different field names (e.g., “QTY_3_355” and “QTY_03_01_355”) for the same element (e.g., “Quantities Ordered”), version mapping can take place between these fields, one as a source field and one as a target field, as an entry in one of the tables. As a result of this version mapping, the field name “QTY_3_355” from a DI report points to the correlation field name “QTY_03_01_355.” Accordingly, the associated entry in the superset is updated so that the correlation field name “QTY_03_01_355” in the superset has a pointer that points to the field name “QTY_3_355” (which is also referred to herein as the DI CVS field name) in the DI report.

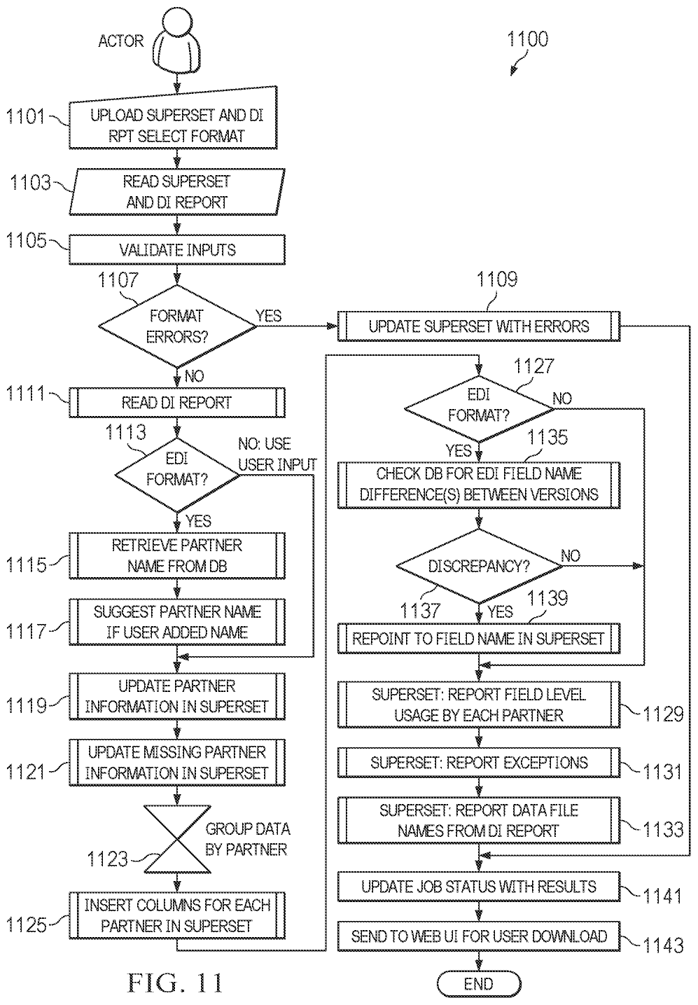

FIG. 11 shows an example of flow 1100 run by a data analyzer according to some embodiments. In this example, the data analyzer takes as input the superset and the DI report uploaded by the user via a UI of the data analyzer (see FIG. 7). The document format (e.g., EDI, XML, SAP IDOC, JSON, flat file, CVS, etc.) for a data analysis process (which, in some embodiments, can include validation) is selected at this time (1101). That is, the user selection drives the flow of the data analyzer.

In some embodiments, the data analyzer reads the superset and the DI report (1103) and validates the inputs (e.g., checking for format errors) (1105). If any format errors are found (1107), the data analyzer updates the superset to include the format errors thus found (1109) and update the job status with the results (1141). Otherwise, the data analyzer reads the DI report again to make sure that the user selected the correct superset for the document type (1111). The data analyzer then determines if the EDI format applies (1113). While data interrogation can be part of the data analysis performed by a data analyzer and a DI report thus generated can be involved in data analyzer flow 1100, the user could input a DI report from another database with known trading partner information (.e.g., entity identifier provided by a user).

If the DI report is in the EDI format, then the data analyzer is operable to retrieve the trading partner name from the database (1115), update the superset (e.g., suggesting trading partner name, updating trading partner information, updating missing trading partner information, etc.) (1117, 1119, 1121), group the data by trading partner (1123), and insert columns for each trading partner (1125), capturing trading partner-specific data usage. Before checking the field names, the data analyzer verifies whether the document format is EDI (1127). If the document type is non-EDI format, the data analyzer is operable to process the superset and report field level usage by each trading partner (1129), report exceptions (1131), and report data file names from the DI report (1133). If the document type is EDI, because there can be multiple EDI versions for the same document type, the data analyzer is operable to check the database for EDI field name difference(s) between different EDI versions (1135). This may entail switching from one row to another and updating the database (e.g., adding a table to define the discrepancy between the EDI versions). If any discrepancy is found (1137), the data analyzer repoints to the field name in the superset (1139) and then report field level usage by each trading partner (1129), report exceptions (1131), and report data file names from the DI report (1133).

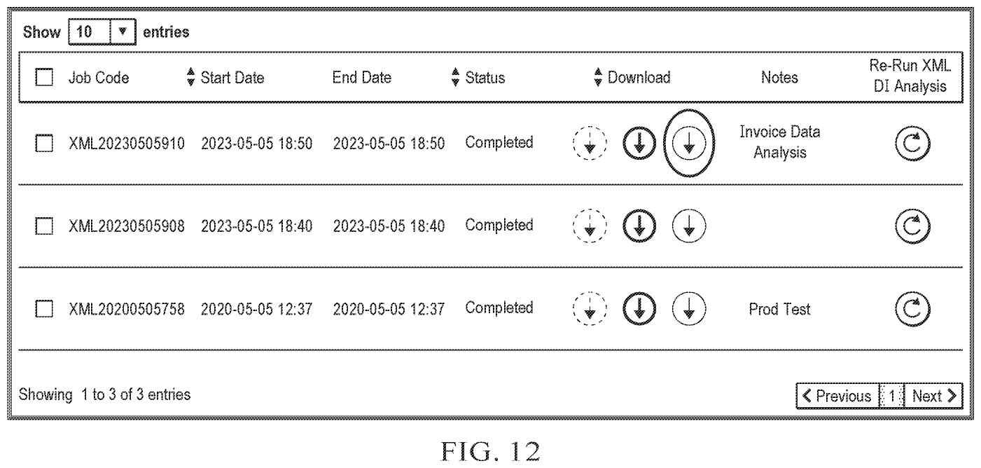

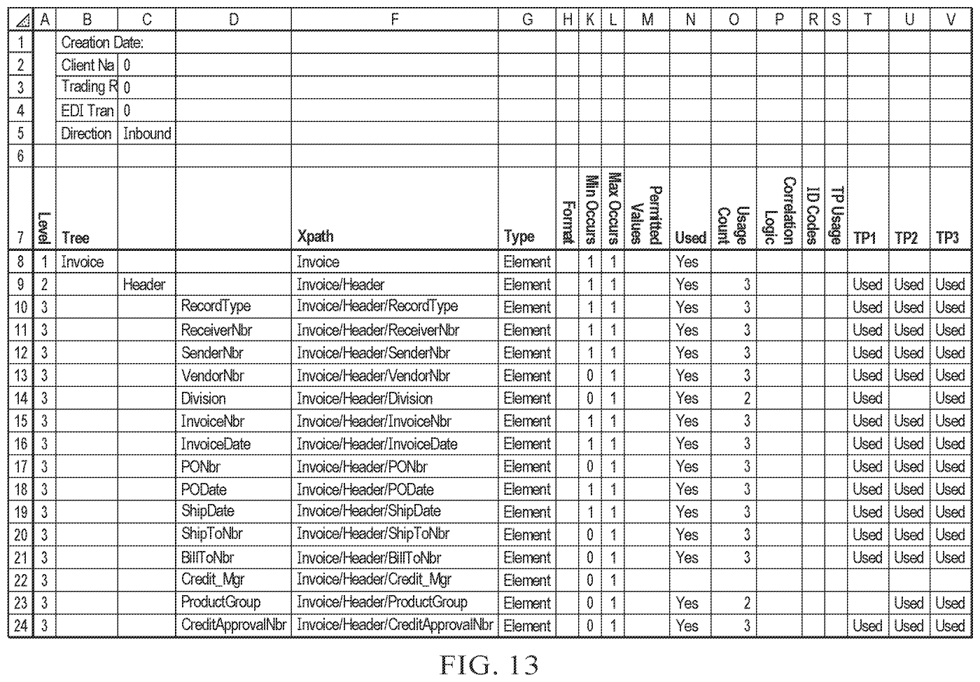

In some embodiments, after updating the job status with the results from flow 1100 (1141), the data analyzer prepares a data analysis report and sends over the web so that the user can download via a UI (see FIG. 12). Unlike the DI report, which is statically generated and which is customer based, the data analysis report thus generated by the data analyzer is dynamically generated and can vary from request to request. FIG. 13 shows a portion of an example of a data analysis report dynamically generated by a data analyzer disclosed herein according to some embodiments.

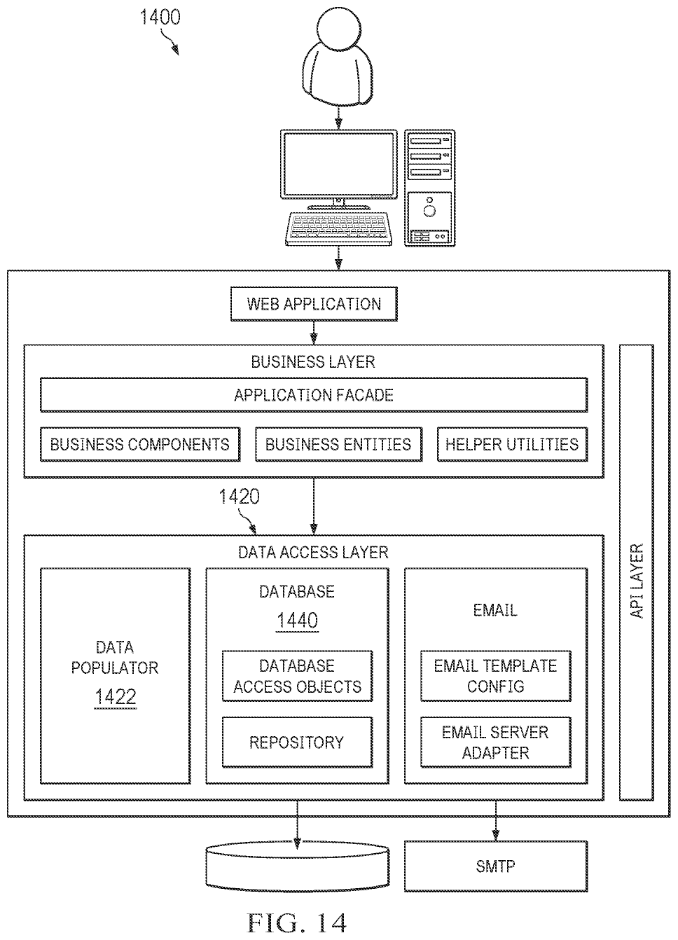

FIG. 14 depicts a diagrammatical representation of an example of the logical architecture of data analyzer 1400 according to some embodiments. In this example, data analyzer 1400 includes data access layer 1420 with database 1440 having tables storing EDI differences. In some embodiments, data populator 1422 is added to data analyzer 1400 for populating database 1440. For example, as discussed above, the data analyzer is operable to check EDI field name differences between EDI versions. Any discrepancies thus found can be stored, via data populator 1442, in database 1440.

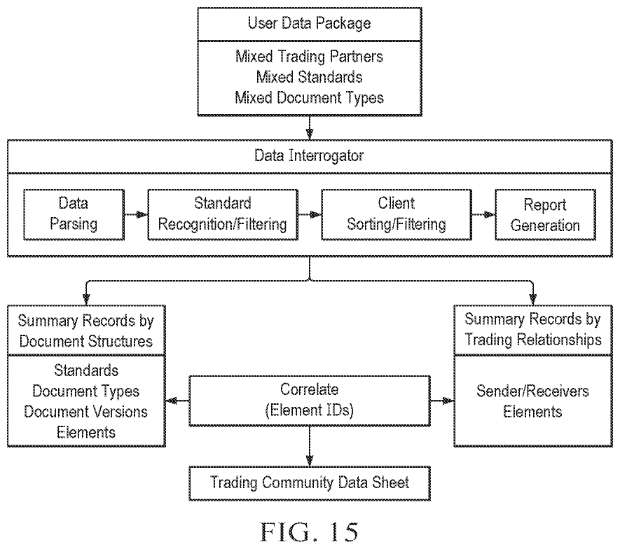

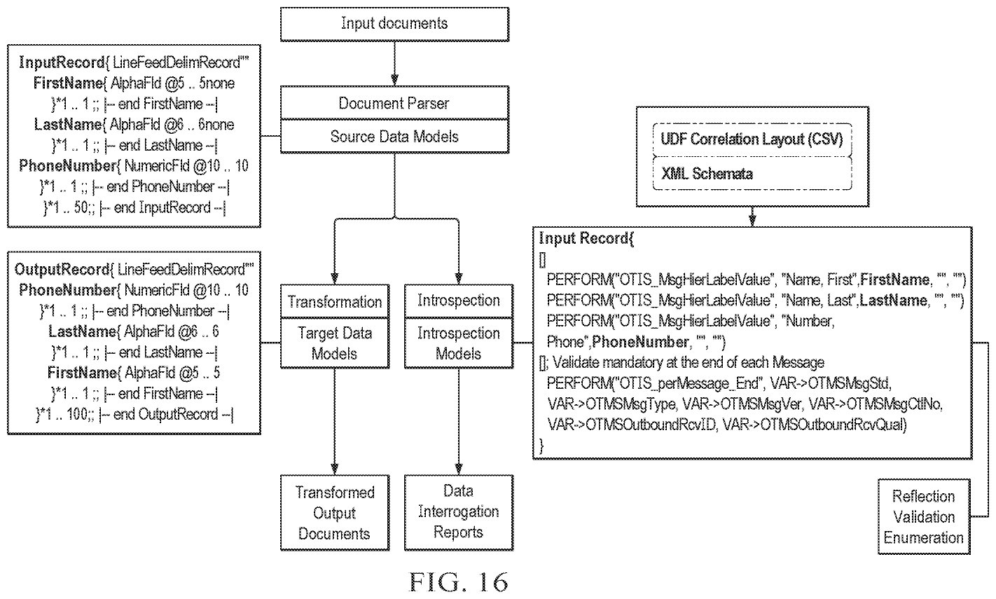

FIG. 15 depicts a logical diagram that illustrates the functionalities of a data interrogator disclosed herein according to some embodiments. FIG. 16 depicts a logical diagram that illustrates the functionality of a document parser that performs introspection with data transformation, working in conjunction with the flexible data model described above.

Initially, profiles are set up/configured for the client and its trading partners. Then, information in a zip package (e.g., thousands of invoices) is processed and provided as input to the data analyzer. The data analyzer runs the information through an industry standard (e.g., VDA, WIX, EDIFACT, etc.) to get the normalized information (e.g., invoices and trading partners found in the data and associated attributes). The client can understand how their partners use the data (e.g., only four of a plurality of trading partners use a particular piece of data item). This kind of deeper understanding of data allows for the elimination of rarely used data and/or provides an ability to combine values. If there is a “one-off” data item, the data analyzer can decide what to do with it as an exception. For instance, if the “one-off” data item is wanted by a trading partner, the data analyzer may utilize a separate data map for the trading partner and the “on-off” data item and its value are not included in the common data map. This kind of adaptive approach allows the data analyzer to discover and fix anomalies to thereby harmonize the data and provide a harmonized view of a canonical standard and data model into a reference data model, even if the data being processed involves a very complex supply chain.

The invention disclosed herein leverages advanced tooling to interrogate and analyze large quantities of ERP and B2B data to create a unified view into all standards and data attributes leveraged across the organization's entire trading community. The DDA service can help organizations to fully understand their B2B integration requirements, which among other things can support the creation of ERP master data layout files (e.g., supersets) and correlating ERP and B2B data. As a result, the invention disclosed herein can significantly speed up the migration.

Based on the detailed understanding of an enterprise customer's B2B environment and mapping it against the enterprise business processes, the invention disclosed herein can help identify further opportunities for process optimization and modelling, as well as data quality improvement. For a migration project, the invention disclosed herein can help managing the risks around migrating B2B connections to the new ERP by applying a parallel testing framework, where integrations with a new system are tested with live data that is duplicated from the existing production environment. This approach allows simulating real-life trading partner behavior on the new ERP system and making any adjustments that are necessary without compromising the actual business processes that continue to run with the old system until testing is complete and the new system is activated.

By having a comprehensive view into the exact B2B and ERP integration requirements and knowing exactly what data an enterprise customer exchanges with their trading partners in the case of a system migration, such as moving to a new ERP system or adopting a new integration platform, allows the enterprise customer to accurately determine the scope of the enterprise's B2B program, define data models and inform the blueprinting of new systems while focusing specifically and only on supply chain data attributes of interest. This specificity can save tremendous amounts of time and money, improve efficiency, and reduce what would otherwise needed to be spent on identifying, defining, and implementing integration requirements.

In the case of a system migration, having detailed insights on the B2B requirements also enables the enterprise customer to define a testing strategy for the new system that accounts for all real-life use cases across the B2B environment. Unlike when defining the testing strategy based on general assumptions, being able to accurately identify all relevant test cases helps to avoid issues and delays at project go-live that might otherwise occur due to surprises related to one-off or otherwise rare requirements of some trading partners.

The DDA service provides a detailed list of errors by document and trading partner along with suggested resolutions. As described above, this is done by comparing large quantities of the actual data that is exchanged with trading partners against the applicable standards, such as ANSI X12, EDIFACT, and others to identify behaviors that deviate from what is defined in the standards. These non-compliant behaviors-either by trading partners or by the enterprise customer, can cause errors in the business process and lead to chargebacks that create unnecessary costs for the parties involved. Therefore, addressing the issues that are discovered can help improve efficiency and effectiveness across the enterprise customer's supply chain operations.

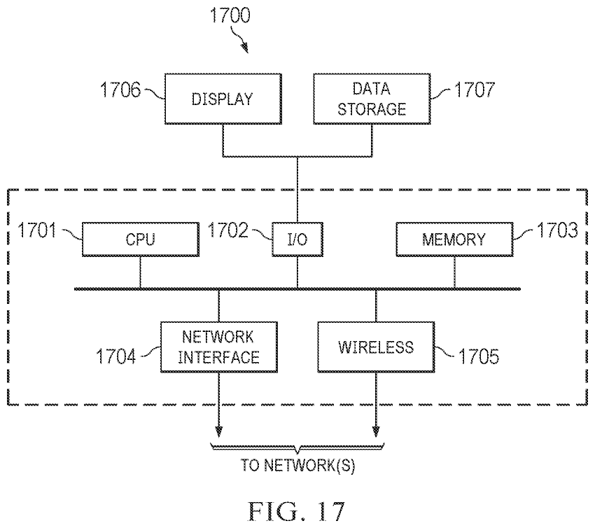

FIG. 17 depicts a diagrammatic representation of a data processing system for implementing an embodiment disclosed herein. As shown in FIG. 17, data processing system 1700 may include one or more central processing units (CPU) or processors 1701 coupled to one or more user input/output (I/O) devices 1702 and memory devices 1703. Examples of I/O devices 1702 may include, but are not limited to, keyboards, displays, monitors, touch screens, printers, electronic pointing devices such as mice, trackballs, styluses, touch pads, or the like. Examples of memory devices 1703 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 1700 can be coupled to display 1706, information device 1707 and various peripheral devices (not shown), such as printers, plotters, speakers, etc. through I/O devices 1702. Data processing system 1700 may also be coupled to external computers or other devices through network interface 1704, wireless transceiver 1705, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Suitable computer-executable instructions may reside on a non-transitory computer readable medium (e.g., ROM, RAM, and/or HD), hardware circuitry or the like, or any combination thereof. Within this disclosure, the term “non-transitory computer readable medium” is not limited to ROM, RAM, and HD and can include any type of data storage medium that can be read by a processor. Examples of non-transitory computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nano-engineered systems, components, and mechanisms may be used. In general, the functions of the invention can be achieved by any means as is known in the art. For example, distributed, or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the accompanying appendix, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and in the accompanying appendix, the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure. The scope of the present disclosure should be determined by the following claims and their legal equivalents.

What is claimed is:

1. A method, comprising:
receiving, by a computer from a client device, a superset and a data interrogation report, the superset corresponding to a document type and containing a column tracking a field name, a column tracking a usage count for the field name, and columns tracking trading partners of an enterprise, the data interrogation report containing field names, usage data, and trading partner data;
validating, by the computer, the superset and the data interrogation report;
updating, by the computer, the superset with information from the interrogation report;
generating, by the computer, a data analysis report based on the updating; and
sending, by the computer, the data analysis report to the client device.

2. The method according to claim 1, wherein the data interrogation report is generated by a data interrogator.

3. The method according to claim 2, wherein generation of the data interrogation report comprises:
receiving a package from the client device, the package containing a file;
determining whether the file has an Electronic Data Interchange (EDI) format;
responsive to the file not having the EDI format:
determining a format of the file; and
creating, on the fly, an internal definition corresponding to the format of the file.

4. The method according to claim 3, wherein the format of the internal definition comprises an XML-type internal definition, an iDOC-type internal definition, a JSON-type internal definition, or a flat file-type internal definition.

5. The method according to claim 3, wherein generation of the data interrogation report further comprises summarizing field-level metadata by trading partner.

6. The method according to claim 2, wherein the data interrogator and the data analyzer are part of a data discovery and analysis service provided by an information exchange platform.

7. The method according to claim 1, wherein the superset comprises a unified data structure for tracking different Electronic Data Interchange (EDI) standards, EDI versions, or a combination thereof.

8. A system, comprising:
a processor;
a non-transitory computer-readable medium; and
instructions stored on the non-transitory computer-readable medium and translatable by the processor for:
receiving, from a client device, a superset and a data interrogation report, the superset corresponding to a document type and containing a column tracking a field name, a column tracking a usage count for the field name, and columns tracking trading partners of an enterprise, the data interrogation report containing field names, usage data, and trading partner data;
validating the superset and the data interrogation report;
updating the superset with information from the interrogation report;
generating a data analysis report based on the updating; and
sending the data analysis report to the client device.

9. The system of claim 8, wherein the data interrogation report is generated by a data interrogator.

10. The system of claim 9, wherein generation of the data interrogation report comprises:
receiving a package from the client device, the package containing a file;
determining whether the file has an Electronic Data Interchange (EDI) format;
responsive to the file not having the EDI format:
determining a format of the file; and
creating, on the fly, an internal definition corresponding to the format of the file.

11. The system of claim 10, wherein the format of the internal definition comprises an XML-type internal definition, an iDOC-type internal definition, a JSON-type internal definition, or a flat file-type internal definition.

12. The system of claim 10, wherein generation of the data interrogation report further comprises summarizing field-level metadata by trading partner.

13. The system of claim 9, wherein the data interrogator and the data analyzer are part of a data discovery and analysis service provided by an information exchange platform.

14. The system of claim 8, wherein the superset comprises a unified data structure for tracking different Electronic Data Interchange (EDI) standards, EDI versions, or a combination thereof.

15. A computer program product comprising a non-transitory computer-readable medium storing instructions translatable by a processor for:
receiving, from a client device, a superset and a data interrogation report, the superset corresponding to a document type and containing a column tracking a field name, a column tracking a usage count for the field name, and columns tracking trading partners of an enterprise, the data interrogation report containing field names, usage data, and trading partner data;
validating the superset and the data interrogation report;
updating the superset with information from the interrogation report;
generating a data analysis report based on the updating; and
sending the data analysis report to the client device.

16. The computer program product of claim 15, wherein the data interrogation report is generated by a data interrogator.

17. The computer program product of claim 16, wherein generation of the data interrogation report comprises:
receiving a package from the client device, the package containing a file;
determining whether the file has an Electronic Data Interchange (EDI) format;
responsive to the file not having the EDI format:
determining a format of the file; and
creating, on the fly, an internal definition corresponding to the format of the file.

18. The computer program product of claim 17, wherein the format of the internal definition comprises an XML-type internal definition, an iDOC-type internal definition, a JSON-type internal definition, or a flat file-type internal definition.

19. The computer program product of claim 17, wherein generation of the data interrogation report further comprises summarizing field-level metadata by trading partner.

20. The computer program product of claim 16, wherein the data interrogator and the data analyzer are part of a data discovery and analysis service provided by an information exchange platform.
